(19) United States
(12) Patent Application Publication
(10) Pub. No.: US 2006/0127663 A1
(43) Pub. Date: Jun. 15, 2006

(54) Foamed material and method for the production of said foamed material

(76) Inventors: Reinhard Strey, Dormgren (DE); Thomas Sottmann, Koln (DE); Michael Schwan, Leverkusen (DE)

Correspondence Address: NEEDLE & ROSENBERG, P.C., SUITE 1000, 999 PEACHTREE STREET, ATLANTA, GA, 30309-3915, US

(21) Appl. No.: 10/540,462

(22) PCT Filed: Dec. 22, 2003
(86) PCT No.: PCT/EP03/14750

§ 371 Date: Nov. 21, 2005

(30) Foreign Application Priority Data
Dec. 23, 2002 (DE) 10260815.6

(51) Int. Cl. B29C 44/46

(52) U.S. Cl. 428/317.9; 264/51

(57) ABSTRACT

The invention relates to a foamed material and to a method for the production of said foamed material. According to the inventive method, foamed material is produced with nanosized foam bubbles Z1 without the need to surmount the energy barrier which usually occurs during phase transitions and nucleation processes. The aim of the invention is to produce a foamed material in a controlled manner, said material having a foam bubble density of 10¹²-10¹⁸ per cm³ and an average foam bubble diameter of 10 nm-10 μm hat. The inventive method is based on the dispersion of a second fluid K2 the form of pools Po in a matrix of a first fluid K1 involving supramolecular interaction of an amphiphile K3. The first fluid K1 is provided as a matrix in the reaction chamber RK and the second fluid K2 is provided in pools. The second fluid K2 is transformed into a near-critical or overcritical state with a near-liquid density by modifying the pressure and/or temperature. The second fluid K2 is provided entirely or almost entirely in the form of pools which are evenly distributed in the entire first fluid K1. Pressure discharge causes the second fluid to return to a state of gaseous density while the pools are blown to form nanosized foam bubbles Z1.

The invention relates to a foamed material and a process for the preparation of said foamed material.

Foamed material is widely known. In principle, there are two processes for the preparation thereof.

In the first process, a foamed polymer material is formed by the principle of nucleation (phase transition), i.e., the formation of bubbles of foaming agent in a supersaturated polymer matrix.

The forming bubble population is subject to the laws of nucleation, according to which the nucleation rate depends on the degree of supersaturation of the system and a nucleation threshold (activation energy) to be overcome. Further, the duration of the nucleation phase and the speed of bubble growth have an influence on the forming foam. To meet a particular requirement, i.e., a particularly high number density of bubbles with great homogeneity, very high nucleation rates and thus high degrees of supersaturation are necessary. The desired monodispersity of the bubbles can be achieved only through a short nucleation phase and thus populations of bubbles having the same age, which in turn requires a very high nucleation rate to allow the large number of bubbles to be formed within a very short period of time.

As far as these processes are understood thermodynamically, the formation of a high foam bubble density has an upper limit, so that foams which rightfully deserve the designation “nanofoam” cannot be produced in this way. When CO₂, for example, is used as a foaming agent, another problem arises in the course of the bubble growth. The decreasing CO₂ concentration within the curing polymer causes the glass transition temperature to rise, which accelerates the curing of the cell walls. This hinders the diffusion of CO₂ into the bubbles on the one hand and the expansion of the bubbles on the other. Consequently, high pressures build within the forming foams, which causes instability of the cell walls.

In another process, foamed material is formed without nucleation and phase transition. A porous structure is produced in the matrix by blowing in foaming agents or by a mechanical mixing process.

It is clear that the latter process is not suitable for obtaining a foamed material which has a high and homogeneous density of foam bubbles.

It is the object of the invention to provide a process for producing a foamed material having nanosize foam bubbles without having to overcome the energy barrier which usually occurs in phase transitions and nucleation processes. A related object is to controllably produce a foamed material which has a number density of foam bubbles of from 10¹² to 10¹⁸ per cm³ and an average density of the foam bubbles of from 10 nm to 10 μm.

These objects are achieved by the process and the material as formulated in the independent claims. Further embodiments of the process and of the material are found in the respective dependent claims.

The core of the invention for providing a foamed material resides in the following:

The foamed material consists of a first fluid forming the matrix and a second fluid forming the foam bubbles (also referred to as foaming agent or expanding agent), wherein said fluids are not completely miscible. Starting substances for the material are at least one first fluid at least one second fluid and an amphiphilic substance. Amphiphilic substances (surfactants) are known; they have at least one polar head or block and at least one nonpolar chain and/or nonpolar head or block. The formation of ordered micellar structures through the supramolecular interaction of the molecular aggregates involved has been known. The invention makes use of this interaction, wherein the first fluid can undergo attractive interaction with at least one block of the amphiphilic material facing towards the first fluid, and the second fluid can undergo attractive interaction with at least one block of the amphiphilic material facing towards the second fluid.

Under the thermodynamic parameters of the preparation, the first fluid involved is in a liquid state of matter, preferably in a low-viscosity state. The second fluid involved is gaseous under the thermodynamic parameters of the preparation. The second fluid can be converted from the gaseous state to a state in which it has a density which is identical with or similar to its density in the liquid state of matter. Thus, the transformation is one in which the gas is converted to a thermodynamic state near the critical point or beyond into the supercritical state. The second fluid is dispersed within the first fluid to form pools (preferably micelles), which are formed with the aid of the amphiphilic material, more specifically by the attractive supramolecular interaction of the first fluid with at least one first block (or head) of the amphiphilic material which faces towards the first fluid and by the attractive interaction of the second fluid with at least one second block (head or chain) of the amphiphilic material which faces towards the second fluid. After the transformation of the second fluid from the state of liquid-like density to the state of gaseous density, i.e., through a change of the thermodynamic quantities to below the critical point (back transition to a subcritical state), the pools are reforrhed to foam bubbles in which the second fluid is nearly completely contained in accordance with the attractive supramolecular interaction.

No energy barrier has to be overcome, nor have the foaming agent molecules to diffuse to the growing bubbles. The processes are directly reversible in the individual steps, which is not the case with thermodynamic processes in which an activation threshold (activation energy) has to be overcome.

The preparation process is provided accordingly.

Preferably, the foam bubble density in the first fluid is within a range of from 10¹² to 10¹⁸ per cm³, and the average foam bubble size is smaller than 10 μm. The total volume of the foam bubbles formed in the first fluid has a volume proportion of from 10 to 99%, depending on the mixing ratio with the second fluid. Preferably, a closed-pore foamed material is formed, while an open-pore material can also be produced by further process steps or by suitable modifications.

At least one substance selected from the group or polar or nearly polar substances is proposed as the first fluid. Under the thermal conditions of the preparation, this substances or mixture of substances should be in a low-viscosity state, preferably in a liquid state or in a state above the glass transition temperature. In particular, the group of substances of the first fluid includes water, short-chain alcohols and mixtures of these liquids with glycerol or with salts. Thus, the thermal conditions of the preparation are not limited to ambient temperatures, but the preparation may also be performed at higher temperatures, and the material prepared be cooled to below the solidification temperature (melting point or glass transition tempera- ture), and used after the matrix has solidified.

Preferably, the first fluid may be at least one polymerizable substance, or the first fluid consists of a mixture in which a polymerizable substance is contained. The use of at least one polymerizable substance may include employing the substance in a nonpolymerized state during the preparation of the foamed material and initiating the polymerization during or at the end of the preparation process. Alternatively, if the first fluid, which is partly or completely polymerizable, is a solid at ambient temperatures, the preparation may be performed at an elevated temperature at which the first fluid is in a molten or softened state. Thus, thermodynamically, the first fluid should be in a liquid state of matter or in a state above the glass transition temperature.

As monomers of a polymerizable substance, acrylamide (polymerized to polyacrylamide) on the one hand or melamine (polymerized to melamine resin) on the other are proposed.

Further, it is proposed to employ at least one additive for initiating or controlling the polymerization. An additive may be a free-radical initiator, an acid, a base or a buffer, for instance.

The second fluid should be selected from a group of substances consisting of. hydrocarbons (methane, ethane etc.), alkanols, fluorochlorohydrocarbons (FCHCs), CO₂.

An amphiphilic material is employed, and any known amphiphilic material with respect to the combination of materials and/or the desired supra molecular interaction of the two fluids can be used. Thus, the amphiphilic substance should have at least one block (head or chain) A facing towards the first fluid, and at least one block (head or chain) B facing towards the second fluid. Thus, amphiphilic substances of the type A-B-A or similar modifications may also be used.

The group of amphiphilic materials at least includes non-ionic, ionic and amphoteric surfactants, amphiphilic block copolymers, fluorinated surfactants, silicone surfactants and/or co-surfactants, mixtures of these also being possible. Known surfactants for short-chain alkanes employed as the first fluid include, for example, non-ionic n-alkyl polyglycol ethers (CᵢEⱼ), n-alkylphenol ethoxylates or n-alkyl-polyglycosides (CₙGₘ).

The group of cationic surfactants includes, for example, alkylammonium bromides, and the anionic surfactants include, for example, the surfactant sodium bis(2-ethylhexyl)sulfosuccinate (AOT) and other alkylsulfates. Further, amphiphilic block copolymers of the type polyethylenepropylene-polyethylene oxide (PEP-PEO), polyethylene oxide-polypropylene oxide-polyethylene oxide (PEO-PPO-PEO, Pluronics) and A-B or A-B-A polymers having a similar structure may also be used for stabilizing the pools.

For CO₂ pools, partially or completely fluorinated alkyl ethoxylates, oligomers or polymers of polydimethylsiloxane-polyethylene oxides (PDMS-PEO) or polydi-methylsiloxane-polyethylene oxides-polypropylene oxides (PDMS-PEO-PPO) as well as the anionic surfactant perfluoropolyetherammonium carboxylate and partially or completely fluorinated amphiphilic fluoropolymers constituted of fluoroacrylate monomers may be employed. Further, amphiphilic block copolymers of the type polybutylene oxide-polyethylene oxide (PBO-PEO), polyethylene oxide-polypropylene oxide-polyethylene oxide (PEO-PPO-PEO, Pluronics) and polymers having a similar structure may also be employed for stabilizing the pools.

For FCHC pools, fluorinated or partially fluorinated surfactants may be used.

What has been said above with respect to the foamed material can be directly transferred to the preparation process. The individual features have been formulated in detail in the corresponding independent claim and the related dependent claims.

Preferably, the process step of converting the density of the second fluid to a state of liquid-like density consists in converting the second fluid to a supercritical or nearly-critical state and, while in this state, dispersing it in the first fluid.

Preferably, in this case, the temperature and/or pressure of the second fluid is raised to a temperature and pressure above the critical temperature and above the critical pressure of the second fluid.

Alternatively, the process step of converting the density of the second fluid to a state of gaseous density can consist in lowering the pressure to a value below the critical pressure.

In this process, the first fluid may preferably consist of at least one polymerizable substance. At least one monomer, at least one prepolymer or at least one polymer may be selected as said polymerizable substance. Therefore, it is proposed to employ an acrylamide or melamine as said polymerizable substance.

Preferably, at least one additive for controlling the polymerization may be employed in the process.

Further, it is advantageous if at least one additive is employed for controlling the interfacial tension between the first and second fluids. For example, an alkanol would be suitable.

In addition, at least one additive for controlling the coalescence of bubbles may be employed in the process. For example, a salt, a polymer or an alcohol would be suitable as a substance for controlling the coalescence of bubbles.

Thus, the invention is based on the dispersion of a second fluid in the form of pools within a matrix of a first fluid. “Matrix” as used herein means a liquid of variable viscosity up to a polymer solidified in a glass-like manner. “Pools” designates the accumulation of molecules of the second fluid in nanometer-sized or micrometer-sized domains (e.g., droplets or micelles). The second fluid serves as a foaming agent.

In a reaction chamber, the first fluid is present as a matrix, and the second fluid is present in pools. The second fluid may also be added gradually to the reaction chamber under a constant or increasing pressure. By changing the pressure and/or temperature, the second fluid is converted to a nearly critical or supercritical state with a density similar to that of a liquid. In this process, the substances are preferably mixed by shear forces, turbulent motion or stirring. Thus, the second fluid is completely or, if its solubility is limited, almost completely present in pools which are dispersed almost uniformly throughout the first fluid. By releasing the pressure, the second fluid is returned to a state of gaseous density, the pools being expanded to foam bubbles.

The process shall also be described in the terminology of microemulsions. The microemulsion consists of at least one first fluid, at least one second fluid and at least one amphiphilic substance. The second fluid, which is stabilized by an amphiphilic substance, is in the form of pools within the first fluid. The second fluid forms swollen micelles. The skilled person calls it “oil-in-water” (o/w) microemulsions. A precondition of the process is that the two fluids have a gas-like density under normal conditions, while they can be compressed under pressure during the preparation process to such an extent as to adopt a liquid-like density, and thus become useful as an oil phase for the microemulsion. The amphiphilic substance may be any suitable surfactant. As mentioned above, further stabilizing or controlling additives may be added. The skilled person is easily capable of transferring the statements to systems which are composed of different process components. In particular, those fluids and amphiphilic substances which are explicitly stated in the claims and in the specification may be employed.

By varying the pressure, temperature and/or composition, the microemulsion is adjusted to produce an oil-in-water (o/w) microemulsion. The conditions are selected in such a way that the second fluid is in a supercritical state or near its critical point.

In this way, a precursor of a nanocellular foam is obtained in which a high number density of the foam bubbles is present due to the high number of swollen pools consisting of the second fluid. By expanding the microemulsion, a continuous volume increase of the pools is achieved. Due to the supercritical state, nucleation for a transition from the liquid to the gaseous phase is not necessary. Thus, in the expansion of supercritical microemulsions, the mechanism of nucleation and phase transition, which is considered disadvantageous, is avoided. The supercritical pools instantaneously and continuously follow a pressure drop with reduction of their density and increase of their volume. The swelling of the pools results in a continuous transition from a microemulsion to a foam, the speed being controllable by the rate of pressure release. These processes are kinetically reversible.

An o/w microemulsion with a number of droplets of up to 10¹⁶ cm⁻³ is an ideal precursor for the desired high number density of foam bubbles. The components of the microemulsion which are employed as the oil phase serve as an expanding agent for the foaming process. Under pressure, the second fluids will be compressed to such an extent as to adopt a liquid-like density and thus become employable as the oil phase for a microemulsion.

The volume of the foam bubbles formed is primarily determined by the contents of the supercritical pools in a state of liquid-like density and the pressure and temperature conditions before and after the expansion. There is no delay from diffusion into the forming foam bubbles. Additional swelling of the foam bubbles can be achieved by further foaming agents, i.e., secondary foaming agents, dissolved in the aqueous microemulsion phase.

Advantages of the Described Process

The number density of the foam bubbles can be selected freely over broad ranges by adjusting the well-known adjustable parameters of microemulsions. By selecting suitable second fluids and suitable amphiphilic substances or mixtures of amphiphilic substances, there is a high flexibility in the formulation of the micro-emulsion to be foamed. Specifically as regards the use of CO₂ as the second fluid, the formulation also of CO₂ microemulsion systems is altogether possible, since amphiphilic substances having the necessary properties of CO₂-philicity or CO₂-phobicity are known to the skilled person and thus available.

Due to the fact that the second fluid is nearly critical or supercritical, the liquid-like density of all foam bubbles developing from the pools can continuously adapt to the external pressure. The density is always at or near the mechanical equilibrium.

The pressure parameter, which propagates instantaneously and isotropically in space, and the uniform composition of the microemulsion in combination enable the preparation of bulk materials having a foam bubble distribution which is very homogeneous in space.

Low pressures and small pressure differences are applied, and the foam bubbles are formed by a continuous expansion which can be controlled exactly. In particular, the expansion can be effected softly to minimize the coalescence of the foam bubbles.

The temperature parameter can be selected freely within broad ranges, provided that its value must be above or near the critical temperature of the foaming agent. By mixing several substances suitable as second fluids, the critical temperature of the mixture can be varied and adjusted.

Advantages of the Material

The foamed material prepared has bubble diameters within a range of the mean free path of the gas molecules. With respect to the technical application of foams, this means that this group of materials has a very low thermal conductivity. Therefore, its use as an improved heat insulation suggests itself.

The foamed material can be employed in various applications. Only some illustrative uses are mentioned here.

The foam can be employed for covering sensitive surfaces of reaction tanks or the surfaces of electronic microdevices, whereby surfaces can be protected against aggressive components of the reaction. Further, the foam can be employed as an effective fire-extinguishing agent due to its high surface area. The foamed material may also be stored under pressure in a container and blown onto a surface as a spray or jet.

The foam produced can be used as a quickly employed shock-absorbing material. For physical reasons, the material has a high sound-absorbing property and can be used accordingly.

As a further application, it is suggested to employ the foamed material as a lubricant in bearings which run under high pressure.

The foamed material can be employed in free atmosphere or inserted in a package screening against the atmosphere. For example, a blister package is a suitable package.

The inventive process has been examined and checked in a laboratory with various systems and in particular detail with a microemulsion of water and ethane as the foaming agent (in a volume ratio of 1:3).and the nonionic surfactant octaethyleneglycol monododecyl ether (C₁₂E₈). For the examinations, pressures were applied which had values greater than the critical pressure of ethane (49 bar). A pressure release to atmospheric pressure was performed at isothermal laboratory conditions. The selected temperature was higher than the critical temperature of ethane (32° C.), for example, 50° C.

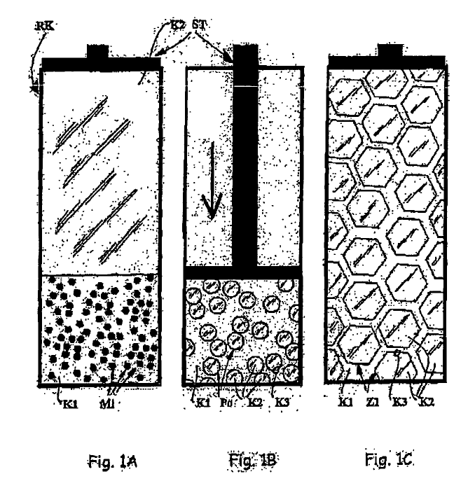

An Example of the invention is shown in the single Figure. FIG. 1 shows the principle of the invention.

For preparing the microemulsion of supercritical ethane (second fluid K2) in water (first fluid K1), a micellar solution of water and C₁₂E₈ surfactant K3 is contacted with gaseous ethane. In the Example of FIG. 1A, micelles Mi in water K1 are covered by a layer of gaseous ethane K2 in the reaction chamber RK under a pressure of p=1 bar and at T=50° C. In FIG. 1B, the pressure is increased to p=100 bar by a piston ST. Homogenization produces the water-ethane-C₁₂E₈ microemulsion with a volume fraction φₒ of liquid supercritical ethane of φₒ=0.01 in water.

A prescribed droplet diameter of the ethane pools (Po) of 2r=10 nm results in a surfactant volume fraction needed in the water-C₁₂E₈ starting solution of φ₅=0.0075. This microemulsion of supercritical ethane has a number density of N=2·10¹⁶ cm⁻³. The ethane microemulsified therein has a fluid density of ρ=4·10² kg·m⁻³.

The formation of the microemulsion is followed by a continuous expansion by lowering the pressure. In FIG. 1C, the state after the end of the expansion (release of the pressure to p=1 bar) can be seen: A nanofoam is obtained. The pools Po have increased in size to form foam bubbles Z1.

During the expansion process, 4 cm³ of foam is formed from 1 cm³ of microemulsion. Due to the expansion to p=1 bar, the droplets expand to a gas density of ρ=1.3 k·m⁻³ to form ethane gas bubbles having a diameter of 2r=60 nm in the water-ethane-C₁₂E₈ mixture. The gas bubbles form a dense foam in which the gas occupies a volume fraction of φ=0.75. Due to coalescence, the number density can decrease to N=5·10¹⁵ cm⁻³ for an optimum saturation of the interface. The size of the bubbles nevertheless remains in the nanometer range.

According to the process presented, it is generally possible to prepare dispersions of a supercritical second fluid with nanometer-size droplets and a high number density as a matrix of a nanofoam.

1-24. (canceled)

25. A foamed material consisting of a first fluid (K1) forming the matrix, a second fluid (K2) forming the foam bubbles (Z1), and an amphiphilic material (K3), wherein said first fluid (K1) can undergo attractive interaction with at least one first block of the amphiphilic material (K3) facing towards the first fluid, and said second fluid (K2) can undergo attractive interaction with at least one second block (B) of the amphiphilic material (K3) facing towards the second fluid;
wherein said first fluid (K1) consists of a material present in a liquid state of matter;
wherein said second fluid (K2) consists of a gaseous material which can be converted to a nearly-critical or supercritical state;
wherein said second fluid (K2) is dispersed in said first fluid (K1) to form pools (Po) through attractive interaction with the respectively facing blocks of said amphiphilic material (K3); and
wherein the pools (Po) have been transformed to foam bubbles (Z1) in which the second fluid (K2) is contained by changing the state of the second fluid (K2) from the previously adjusted state to the subcritical state.

26. The foamed material according to claim 25, wherein the material of said first fluid (K1) is in a low-viscosity state.

27. The foamed material according to claim 25, wherein said foam bubble density in the first fluid (K1) is from 10¹² to 10¹⁸ per cm³, depending on the mixing ratio between the fluids (K1, K2), the average foam bubble size is smaller than 10 μm, and the total volume of the foam bubbles (Z1) formed in the first fluid (K1) has a volume proportion of from 10 to 99%.

28. The foamed material according to claim 25, wherein said first fluid (K1) is at least one substance selected from the group of substances consisting of polar substances and nearly polar substances.

29. The foamed material according to claim 25, wherein said first fluid (K1) consists of at least one polymerizable substance.

30. The foamed material according to claim 29, wherein the monomers of said polymerizable substance are selected from the group consisting of acrylamide and melamine.

31. The foamed material according to claim 25, wherein said first fluid (K1) consists of a mixture which contains at least one polymerizable substance.

32. The foamed material according to claim 31, wherein the monomers of said polymerizable substance are selected from the group consisting of acrylamide and melamine.

33. The foamed material according to claim 25, wherein said second fluid (K2) is at least one substance selected from the group of substances consisting of hydrocarbons, alkanols, fluorochlorohydrocarbons and CO₂.

34. The foamed material according to claim 25, wherein said amphiphilic material (K3) is at least one substance selected from the group of substances consisting of non-ionic, ionic and amphoteric surfactants, amphiphilic block copolymers, fluorinated surfactants, silicone surfactants and co-surfactants.

35. The foamed material according to claim 25, wherein water is employed as said first fluid (K1), ethane is employed as said second fluid (K2), and octaethylene glycol monododecyl ether is employed as said amphiphilic material (K3).

36. A process for the preparation of a foamed material using a first fluid (K1) forming the matrix, a second fluid (K2) forming the foam bubbles (Z1) and an amphiphilic material (K3), wherein said first fluid (K1) can undergo attractive interaction with at least one first block of the amphiphilic material (K3) facing towards the first fluid, and said second fluid (K2) can undergo attractive interaction with at least one second block (B) of the amphiphilic material (K3) facing towards the second fluid;
wherein said first fluid (K1) consists of a material present in a liquid state of matter;
wherein said second fluid (K2) consists of a gaseous material which can be converted to a nearly-critical or supercritical state;
comprising the following process steps performed in a reaction chamber:
said second fluid (K2) is converted by changing its state from the subcritical state to a nearly-critical or supercritical state;
said second fluid (K2) is dispersed in said first fluid (K1) to form pools (Po) through attractive interaction with the respectively facing blocks of said amphiphilic material (K3); and
said second fluid (K2) is converted by changing its state from the previously adjusted state to the subcritical state;
wherein the pools (Po) are transformed to foam bubbles (Z1) in which the second fluid (K2) is contained.

37. The foamed material according to claim 36, wherein the material of said first fluid (K1) is in a low-viscosity state.

38. The process according to claim 36, wherein the process step of converting the density of said second fluid (K2) to a state of liquid-like density consists in converting said second fluid (K2) to a supercritical or nearly critical state and, while in this state, dispersing it in the first fluid (K1).

39. The process according to claim 38, wherein the temperature of the second fluid (K2) is raised to a temperature above the critical temperature of the second fluid (K2).

40. The process according to claim 39, wherein the temperature and pressure of the second fluid (K2) is raised to a temperature and pressure above the critical temperature and above the critical pressure of the second fluid (K2).

41. The process according to claim 38, wherein the pressure of the second fluid (K2) is raised to a pressure above the critical pressure of the second fluid (K2).

42. The process according to claim 36, wherein the process step of converting the density of said second fluid (K2) to a state of gaseous density consists in lowering the pressure to a value below the critical pressure.

43. The process according to claim 36, wherein the process step of converting the density of said second fluid (K2) to a state of gaseous density consists in lowering the pressure to a value below the critical pressure and lowering the temperature to a value below the critical temperature.

44. The process according to claim 36, wherein the process step of converting the density of said second fluid (K2) to a state of gaseous density consists in lowering the temperature to a value below the critical temperature.

45. The process according to claim 36, wherein said dispersing of the second fluid (K2) in said first fluid (K1) is accompanied by a homogenization measure.

46. The process according to claim 36, wherein said first fluid (K1) is at least one substance selected from the group of substances consisting of polar substances and nearly polar substances.

47. The process according to claim 36, wherein at least one polymerizable substance is employed as said first fluid (K1).

48. The process according to claim 47, wherein the monomers of said polymerizable substance are selected from the group consisting of acrylamide and melamine.

49. The process according to claim 36, wherein a mixture which contains at least one polymerizable substance is employed as said first fluid (K1).

50. The process according to claim 49, wherein the monomers of said polymerizable substance are selected from the group consisting of acrylamide and melamine.

51. The process according to claim 47, wherein at least one additive for controlling the polymerization is employed.

52. The process according to claim 51, wherein at least one additive for controlling the polymerization is employed.

53. The process according to claim 36, wherein at least one substance selected from the group of substances consisting of hydrocarbons, alkanols, fluorochlorohydrocarbons and/or CO₂ is employed as said second fluid (K2).

54. The process according to claim 36, wherein at least one substance selected from the group of substances consisting of non-ionic, ionic and amphoteric surfactants, amphiphilic block copolymers, fluorinated surfactants, silicone surfactants and/or co-surfactants is employed as said amphiphilic material (K3).

55. The process according to claim 53, wherein water is selected as said first fluid (K1), ethane is selected as said second fluid (K2), and octaethylene glycol monododecyl ether is selected as said amphiphilic material (K3).

56. The process according to claim 55, wherein water is selected as said first fluid (K1), ethane is selected as said second fluid (K2), and octaethylene glycol monododecyl ether is selected as said amphiphilic material (K3).

57. The process according to claim 36, wherein at least one additive is employed for controlling the interfacial tension between said first and second fluids.

58. The process according to claim 36, wherein at least one additive is employed for controlling the coalescence of bubbles.
